(19) United States
(12) Patent Application Publication
(10) Pub. No.: US 2025/0226554 A1
(43) Pub. Date: Jul. 10, 2025

(54) POWER SUPPLY INCLUDING A MANUAL SERVICE DISCONNECT (MSD) HAVING PYRO FUSE

(71) Applicant: GM Global Technology Operations LLC, Detroit, MI (US)

(72) Inventors: Timothy Glenn Ross, Washington, MI (US); Amar Sahib, Orion Township, MI (US); Jacob Lee Maxwell, Highland, MI (US)

(21) Appl. No.: 18/404,035

(22) Filed: Jan. 4, 2024

(51) Int. Cl. H01M 50/583; B60L 3/00; B60L 50/64; H01M 10/42

(52) U.S. Cl. CPC H01M 50/583; B60L 3/0046; B60L 50/64; H01M 10/425

(57) ABSTRACT

A power supply includes a housing having a plurality of walls, a power component arranged in the housing, a first electrical connector connected to the power component, a second electrical connector connected to the power component, an electric circuit defined between the first electrical connector, the second electrical connector, and the power component, and a manual disconnect device (MSD) including a pyro fuse connected in the electric circuit, the MSD being provided on the housing and being configured to create an open in the electric circuit.

### INTRODUCTION

The subject disclosure relates to power supplies and, more particularly, to a power supply including a manual service disconnect having a pyro fuse.

Power supplies, particularly battery-type energy storage devices, are used to provide energy to an electrical load. The power supply may include a plurality of cells that store and discharge the electric energy. For a variety of reasons, the battery may discharge energy through an electric circuit at a rate that exceeds design thresholds or may be charged through the electric circuit by a charging device that does not meet design requirements. At such time, it is desirable to disconnect the power supply from the electrical load.

Currently, power supplies, particularly high voltage power supplies, include a fuse that is responsive to an over current condition to interrupt or create an open in the electric circuit. In many instances, the fuse is a fast acting fuse that may employ an amount of pyrotechnic material to break contacts and open the electric circuit. The fuse, when triggered, quickly opens the electric circuit to protect internal battery components. The fuse is a single use device that, once triggered, requires replacement. Currently replacing the fuse is a time consuming and work intensive endeavor typically requiring significant disassembly of the power supply. Accordingly, it is desirable to provide a fuse that is readily accessible and easily replaceable.

### SUMMARY

A power supply, in accordance with a non-limiting example, includes a housing having a plurality of walls, a power component arranged in the housing, a first electrical connector connected to the power component, a second electrical connector connected to the power component, an electric circuit defined between the first electrical connector, the second electrical connector, and the power component, and a manual disconnect device (MSD) including a pyro fuse connected in the electric circuit, the MSD being provided on the housing and being configured to create an open in the electric circuit.

In addition to one or more of the features described herein the MSD is mounted to one of the plurality of walls.

In addition to one or more of the features described herein the housing includes a cover, the MSD being mounted to the cover.

In addition to one or more of the features described herein the power component includes a power storage system including a plurality of battery cells arranged in the housing.

In addition to one or more of the features described herein the MSD includes a base portion mounted to the housing and an electrical contact portion that is selectively removeable from the base portion.

In addition to one or more of the features described herein the MSD includes a handle pivotally mounted to the electrical contact portion.

In addition to one or more of the features described herein the MSD includes a latch element that secures the electrical contact portion to the base portion.

In addition to one or more of the features described herein the pyro fuse is mounted in the electrical contact portion.

In addition to one or more of the features described herein the electrical contact portion includes a low voltage circuit connected to the pyro fuse, the low voltage circuit including a low voltage connector.

In addition to one or more of the features described herein the electric circuit includes a positive portion and a negative portion, the MSD being arranged in the positive portion.

A manual service disconnect (MSD) for a power supply having an electric circuit includes a pyro fuse connected in the electric circuit. The MSD being configured to create an open in the electric circuit through activation of the pyro fuse.

In addition to one or more of the features described herein the MSD includes a base portion and an electrical contact portion that is selectively removeable from the base portion.

In addition to one or more of the features described herein the electrical contact portion includes a rotatable handle.

In addition to one or more of the features described herein the rotatable handle includes a latch element that secures the electrical contact portion to the base portion.

In addition to one or more of the features described herein the pyro fuse is mounted in the electrical contact portion.

In addition to one or more of the features described herein the electrical contact portion includes a low voltage circuit connected to the pyro fuse, the low voltage circuit including a first low voltage connector mounted in the electrical contact portion.

In addition to one or more of the features described herein the base portion includes a second low voltage connector arranged in the base portion, the second low voltage connector being configured to operatively connect with the first low voltage connector.

In addition to one or more of the features described herein a triggering device is operatively connected to the low voltage circuit, the triggering device being configured to signal the pyro fuse to create an open in the electric circuit.

In addition to one or more of the features described herein the electrical contact portion includes a first high voltage contact and a second high voltage contact joined by a bridge member, the pyro fuse including a cleaver positioned at the bridge member.

In addition to one or more of the features described herein the pyro fuse includes a pyro charge operatively connected to the low voltage circuit, the pyro charge being configured to selectively drive the cleaver through the bridge member to create the open in the electric circuit.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a perspective view of a power supply including a manual service disconnect (MSD) including a pyro fuse, in accordance with a non-limiting example;

FIG. 2 is a schematic diagram illustrating an electrical circuit of the power supply including the MSD connected between a power component of the power supply and an electrical load, in accordance with a non-limiting example;

FIG. 3 is a perspective view of the MSD of FIG. 2 including a base portion and an electrical contact portion, in accordance with a non-limiting example;

FIG. 4 is an underside view of the electrical contact portion of the MSD of FIG. 3, in accordance with a non-limiting example;

FIG. 5 is a cross-sectional schematic view illustrating the pyro fuse prior to severing an electric circuit, in accordance with a non-limiting example;

FIG. 6 is a cross-sectional schematic view illustrating the pyro fuse after severing the electric circuit, in accordance with a non-limiting example;

FIG. 7 is a perspective view of a latch mechanism of the MSD of FIG. 3 being disengaged, in accordance with a non-limiting example; and

FIG. 8 is a perspective view of the MSD of FIG. 6 showing the electrical contact portion being removed from the base portion, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

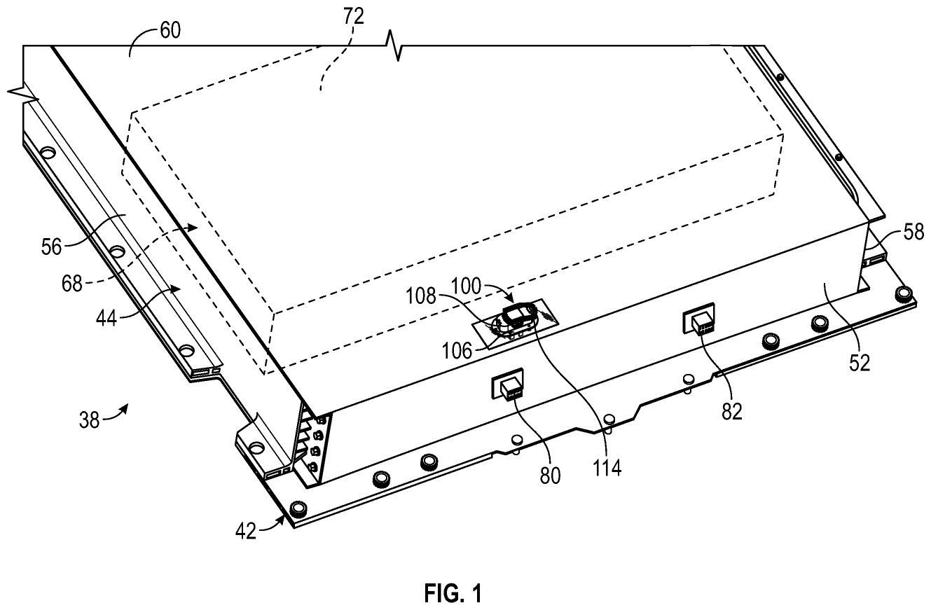

A power supply, in accordance with a non-limiting example, is indicated generally at 38 in FIG. 1. Power supply 38 includes a housing 42 having a plurality of walls 44 including at least a first end wall 52, a second end wall (not shown), a first side wall 56, a second side wall 58, and a cover 60. Housing 42 encloses a power component 68. In the non-limiting example shown, power component 68 is defined by a plurality of rechargeable battery cells 72. However, it should be understood that power component 68 may take a variety of forms including generators, transformers, and the like.

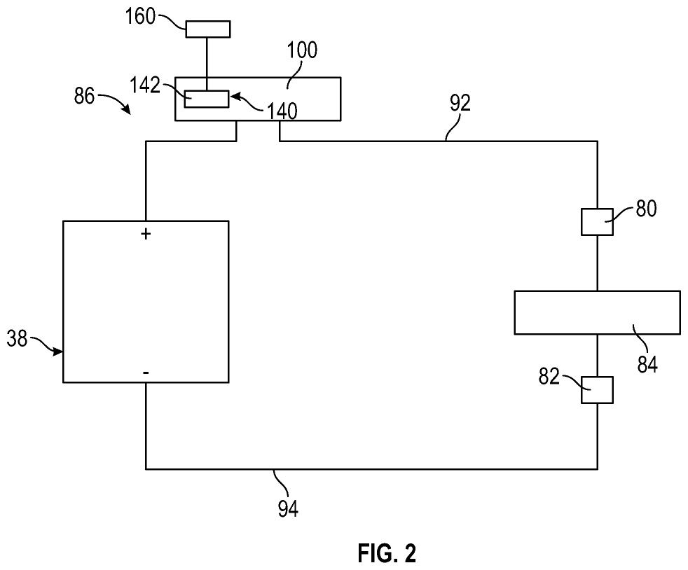

In a non-limiting example, a first electrical connector 80 and a second electrical connector 82 are mounted to first end wall 52. First electrical connector 80 and second electrical connector 82 provide a connection to an electrical load 84 (FIG. 2) connected to power supply 38. As shown in FIG. 2, an electric circuit 86 is defined between first electrical connector 80 and second electrical connector 82. Electric circuit 86 operatively connects power supply 38 to electrical load 84. In a non-limiting example, electric circuit 86 includes a positive portion 92 that extends between a positive terminal (not separately labeled) of power supply 38 and first electrical connector 80 and a negative portion 94 that extends between a negative terminal (also not separately labeled) of power supply 38 and second electrical connector 82.

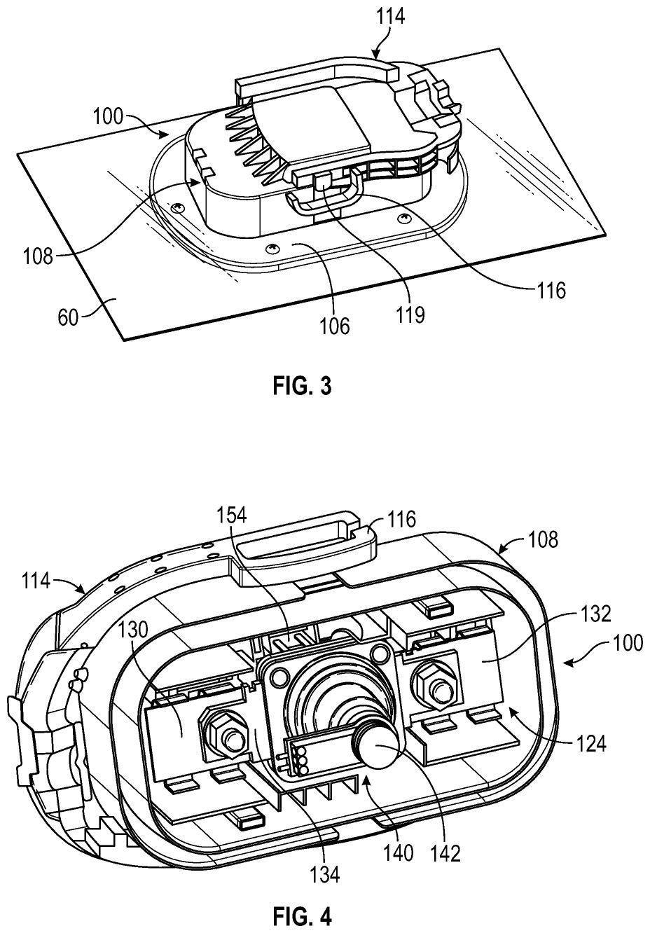

In a non-limiting example, power supply 38 includes manual service disconnect (MSD) 100 arranged in electric circuit 86. In one non-limiting example, MSD 100 is mounted to cover 60 (FIG. 1) and positioned to interrupt a flow of current passing through positive portion 92 of electric circuit 86 to electrical load 84. Referring to FIG. 3, MSD 100 includes a base portion 106 and an electrical contact portion 108. Base portion 106 includes a recess or receptacle 110 (FIG. 8) that engages electrical contact portion 108. With this configuration, electrical contact portion 108 is detachably connected to base portion 106.

When electrical contact portion 108 is connected to base portion 106 electrical current flows through electric circuit 86 from power supply 38 to electrical load 84. When electrical contact portion 108 is removed from base portion 106, an open circuit is created interrupting electrical current flow. In one non-limiting example, electrical contact portion 108 includes a handle 114 having a latch element 116. Base portion 106 includes a projection 119 that aligns with handle 114 and is selectively engaged by latch element 116.

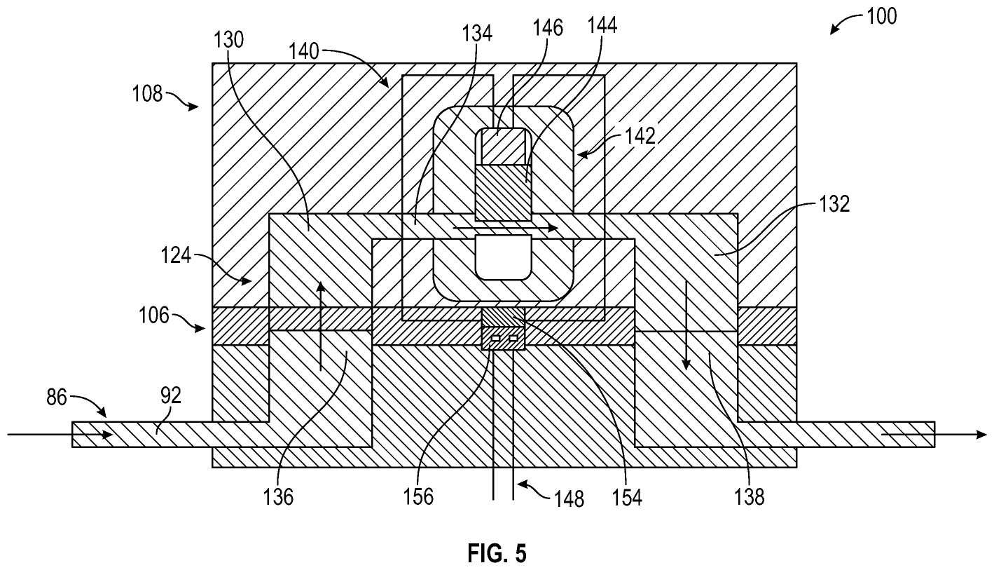

In a non-limiting example illustrated in FIG. 4, MSD 100 includes a circuit portion 124 that forms part of electric circuit 86. Circuit portion 124 includes a first high voltage contact 130 and a second high voltage contact 132 joined by a bridge member 134 in electrical contact portion 108. As shown in FIG. 5, a third high voltage contact 136 and a fourth high voltage contact 138 are arranged in base portion 106. Third high voltage contact and fourth high voltage contact 138 are connected to electric circuit 86.

When electric contact portion 108 is engaged with base portion 106, first high voltage contact 130 and third high voltage contact 136 are electrically connected and second high voltage contact 132 and fourth high voltage contact 138 are electrically connected. When separated, electrical flow in electric circuit 86 is cut-off. In addition to cutting off electrical flow by removing electrical contact portion 108 from base portion 106, MSD 100 also includes a circuit interrupter portion 140 that acts to rapidly cut off electrical flow in response to an operational condition of power supply 38. Circuit interrupter portion 140 may sever electric circuit 86 in the event operating temperatures, currents, or the like in power supply 38 exceed design parameters.

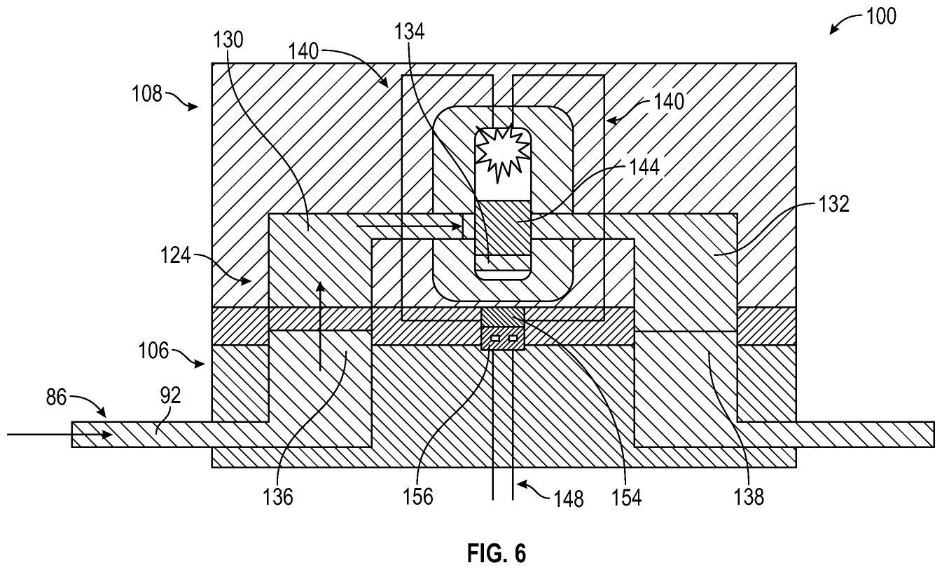

Referring to FIG. 5 and with continued reference to FIG. 4, electrical contact portion 108 also includes a circuit interrupter portion 140 having a pyro fuse 142 arranged to sever bridge member 134 and open electric circuit 86. As shown in FIG. 5, pyro fuse 142 includes a cleaver 144 arranged adjacent to bridge member 134 and a pyro charge 146 positioned adjacent to cleaver 144. Ignition of pyro charge 146 drives cleaver 144 through bridge member 134 severing electric circuit 86 as shown in FIG. 6. In a non-limiting example, pyro fuse 142 further includes a low voltage circuit 148 connected to pyro charge 146.

Low voltage circuit 148 includes a first low voltage connector 154 provided in electrical contact portion 108 and a second low voltage connector 156 provided in base portion 106. Low voltage circuit 148 is completed when electrical contact portion 108 is engaged with base portion 106. Low voltage circuit 148 is connected to a triggering device 160 (FIG. 2) that signals pyro fuse 142 to ignite pyro charge 146 to drive cleaver 144 through bridge member 134 and open electric circuit 86. This is upon detection of an out of parameter operating conditions, triggering device causes pyro fuse to immediately open electric circuit 86. They use of pyro charge 146 ensures that the opening occurs in 2 ms or less. At this point it should be understood that the term “low voltage” describes voltage is less than or equal to 30 VAC or 60 VDC and the term “high voltage” describes voltage that is greater than 30 VAC or 60 VDC.

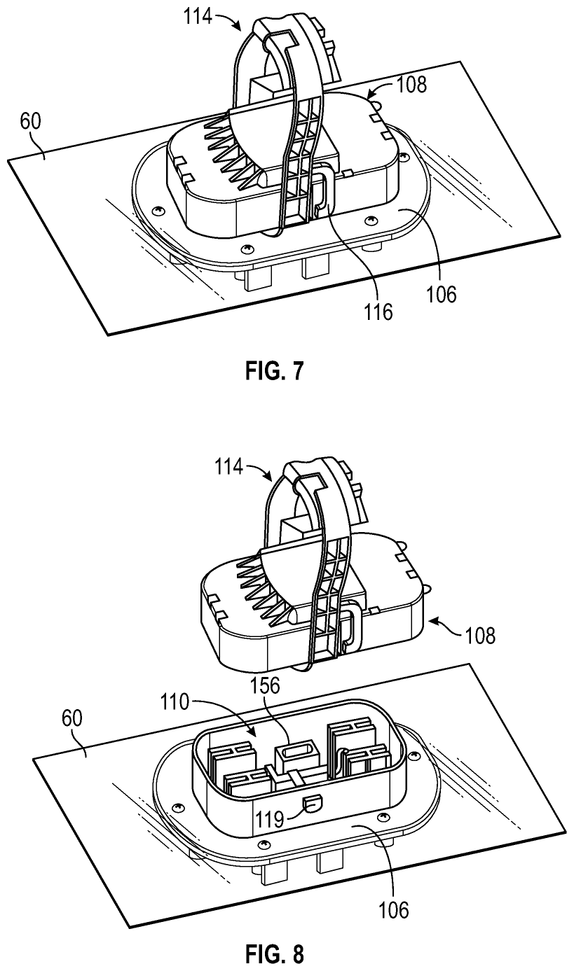

To manually disconnect power supply 38 from electric circuit 86, electrical contact portion 108 is simply removed from base portion 106. To remove electrical contact portion 108 from base portion 106 handle 114 is rotated as shown in FIG. 7. Rotation of handle 114 disengages latch element 116 from projection 119. When latch element 116 is disengaged from projection 119, electrical contact portion 108 may be removed from base portion 106 as shown in FIG. 8 to interrupt a flow of electricity from power supply 38 to electric circuit 86. By arranging MSD 100 in a readily accessible area (e.g., cover 60), electrical current may be more easily cut off during servicing of any load connected to power supply 38. Further, in the event of a fuse failure, replacement of electrical contact portion 108 may be achieved without the need to disassemble power supply 38. Further, by incorporating pyro fuse 142 into MSD 100 repair or replacement of electrical contact portion 108 in the event that pyro charge 146 is triggered may be readily accomplished.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The terms “about” and “substantially” are intended to include the degree of error associated with measurement of the particular quantity based upon the equipment available at the time of filing the application. For example, “about” and/or “substantially” can include a range of +8% or 5%, or 2% of a given value.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A power supply comprising:
a housing having a plurality of walls;
a power component arranged in the housing;
a first electrical connector connected to the power component;
a second electrical connector connected to the power component;
an electric circuit defined between the first electrical connector, the second electrical connector, and the power component; and
a manual disconnect device (MSD) including a pyro fuse connected in one of the electric circuit, the MSD being provided on the housing and being configured to create an open in the electric circuit.

2. The power supply according to claim 1, wherein the MSD is mounted to one of the plurality of walls.

3. The power supply according to claim 1, wherein the housing includes a cover, the MSD being mounted to the cover.

4. The power supply according to claim 1, wherein the power component includes a power storage system including a plurality of battery cells arranged in the housing.

5. The power supply according to claim 1, wherein the MSD includes a base portion mounted to the housing and an electrical contact portion that is selectively removeable from the base portion.

6. The power supply according to claim 5, wherein the MSD includes a handle pivotally mounted to the electrical contact portion.

7. The power supply according to claim 6, wherein the MSD includes a latch element that secures the electrical contact portion to the base portion.

8. The power supply according to claim 5, wherein the pyro fuse is mounted in the electrical contact portion.

9. The power supply according to claim 8, wherein the electrical contact portion includes a low voltage circuit connected to the pyro fuse, the low voltage circuit including a low voltage connector.

10. The power supply according to claim 1, wherein the electric circuit includes a positive portion and a negative portion, the MSD being arranged in the positive portion.

11. A manual service disconnect (MSD) for a power supply having an electric circuit, the MSD comprising:
a pyro fuse connected in the electric circuit, the MSD being configured to create an open in the electric circuit through activation of the pyro fuse.

12. The MSD according to claim 11, wherein the MSD includes a base portion and an electrical contact portion that is selectively removeable from the base portion.

13. The MSD according to claim 12, wherein the electrical contact portion includes a rotatable handle.

14. The MSD according to claim 13, wherein the rotatable handle includes a latch element that secures the electrical contact portion to the base portion.

15. The MSD according to claim 12, wherein the pyro fuse is mounted in the electrical contact portion.

16. The MSD according to claim 15, wherein the electrical contact portion includes a low voltage circuit connected to the pyro fuse, the low voltage circuit including a first low voltage connector mounted in the electrical contact portion.

17. The MSD according to claim 16, wherein the base portion includes a second low voltage connector arranged in the base portion, the second low voltage connector being configured to operatively connect with the first low voltage connector.

18. The MSD according to claim 17, further comprising a triggering device operatively connected to the low voltage circuit, the triggering device being configured to signal the pyro fuse to create an open in the electric circuit.

19. The MSD according to claim 18, wherein the electrical contact portion includes a first high voltage contact and a second high voltage contact joined by a bridge member, the pyro fuse including a cleaver positioned at the bridge member.

20. The MSD according to claim 19, wherein the pyro fuse includes a pyro charge operatively connected to the low voltage circuit, the pyro charge being configured to selectively drive the cleaver through the bridge member to create the open in the electric circuit.
